(19) United States
(12) Patent Application Publication
(10) Pub. No.: US 2014/0280296 A1
(43) Pub. Date: Sep. 18, 2014

(54) PROVIDING HELP INFORMATION BASED ON EMOTION DETECTION

(71) Applicant: GOOGLE INC., (US)

(72) Inventors: Nicholas JOHNSTON, Mountain View, CA (US); Ryan Patrick DOHERTY, Mountain View, CA (US); Willard Kevin MCCLELLAN, Mountain View, CA (US)

(73) Assignee: GOOGLE INC., Mountain View, CA (US)

(21) Appl. No.: 13/826,179

(22) Filed: Mar. 14, 2013

(51) Int. Cl. G06F 17/30

(52) U.S. Cl. CPC G06F 17/30011
USPC 707/769

(57) ABSTRACT

A device may detect a negative emotion of a user and identify, based on detecting the negative emotion of the user, a task being performed by the user in relation to an item. The device may obtain, based on identifying the task, information to aid the user in performing the identified task in relation to the item. The information may include at least one of information, obtained from a memory associated with the device, in a help document, a user manual, or an instruction manual relating to performing the task in relation to the item; information, obtained from a network, identifying a document relating to performing the task in relation to the item; or information identifying a video relating to performing the task in relation to the item. The device may provide the obtained information to the user.

### BACKGROUND

Individuals can become frustrated when performing all types of tasks. For example, an individual can become frustrated trying to perform tasks on the user's computer, smart phone, set-top box, etc. In addition, an individual can become frustrated when attempting to perform non-device-related tasks, such as assembling a piece of furniture, preparing a meal, etc.

### SUMMARY

According to some possible implementations, a method includes detecting, by one or more processors of a device, a negative emotion of a user; identifying, by the one or more processors and based on detecting the negative emotion of the user, a task being performed by the user in relation to an item; obtaining, by the one or more processors and based on identifying the task, information to aid the user in performing the identified task in relation to the item. The information includes at least one of information, obtained from a memory associated with the device, in a help document, a user manual, or an instruction manual relating to performing the task in relation to the item; information, obtained from a network, identifying a document relating to performing the task in relation to the item; or information identifying a video relating to performing the task in relation to the item. The method further includes providing, by the one or more processors, the obtained information to the user.

According to some possible implementations, identifying the task includes identifying at least one of the task or the item based on analyzing one or more of an image or video of the user performing the task in relation to the item, a search history associated with the user, a purchase history associated with the user, social activity associated with the user, or a verbal communication associated with the user or another user.

According to some possible implementations, the item corresponds to an application executing on the device, and where obtaining the information to aid the user in performing the task in relation to the item includes obtaining information from a help document of the application.

According to some possible implementations, obtaining the information to aid the user in performing the task in relation to the item includes sending a search query, over the network, to a server, the search query including information identifying the task and the item; and receiving, based on sending the search query, at least one of the information identifying a document relating to performing the task in relation to the item, or the information identifying a video relating to performing the task in relation to the item.

According to some possible implementations, the method further includes providing a list of options to the user, where the list of options includes a first option to obtain a help document associated with the item, a user manual, or an instruction manual, a second option to obtain a document from the network, and a third option to obtain a video from the network. The method further includes detecting a selection of the first option, the second option, or the third option, and where providing the obtained information to the user includes providing the obtained information based on the selection of the first option, the second option, or the third option.

According to some possible implementations, the task includes a group of steps, where identifying the task includes identifying a particular step, of the group of steps, being performed by the user when the negative emotion was detected, and where obtaining the information to aid the user in performing the task includes obtaining information relating to the particular step.

According to some possible implementations, providing the obtained information includes providing the obtained information on a display device.

According to some possible implementations, a system includes one or more processors to detect a negative emotion of a user; and identify, based on detecting the negative emotion of the user, a task being performed by the user in relation to an item. When identifying the task, the one or more processors are to identify at least one of the task or the item based on analyzing one or more of an image or video of the user performing the task in relation to the item, a search history associated with the user, a purchase history associated with the user, or social activity associated with the user. The one or more processors are further to obtain, based on identifying the task, information to aid the user in performing the identified task in relation to the item, and provide the obtained information to the user.

According to some possible implementations, the information includes at least one of information, from a memory associated with the device, in a help document, a user manual, or an instruction manual; document-based information, obtained from a network, relating to performing the task in relation to the identified item; or video-based information relating to performing the task in relation to the identified item.

According to some possible implementations, the item corresponds to an application being executed by a processor of the one or more processors, and where, when obtaining the information to aid the user in performing the task in relation to the item, the one or more processors are to obtain information from a help document associated with the application.

According to some possible implementations, when obtaining the information to aid the user in performing the task, the one or more processors are to send a search query, via the network, to a server, where the search query includes information identifying the item and the task; and receive, based on sending the search query, the information to aid the user in performing the identified task in relation to the item.

According to some possible implementations, the one or more processors are further to provide a list of options to the user, where the list of options includes a first option to obtain one or more of a help document, a user manual, or an instruction manual, a second option to obtain a document from the network, and a third option to obtain a video from the network. The one or more processors are further to detect a selection of the first option, the second option, or the third option, and where, when providing the obtained information to the user, the one or more processors are to provide the obtained information based on the selection of the first option, the second option, or the third option.

According to some possible implementations, the task includes a group of steps, where when identifying the task, the one or more processors are to identify a particular step, of the group of steps, being performed by the user when the negative emotion was detected, and where when obtaining the information to aid the user in performing the task, the one or more processors are to obtain information relating to the particular step.

According to some possible implementations, when providing the obtained information, the one or more processors are to provide the obtained information on a display device.

According to some possible implementations, a computer-readable medium stores instructions. The instructions include a group of instructions, which, when executed by one or more processors of a device, causes the one or more processors to detect a negative emotion of a user; identify, based on detecting the negative emotion of the user, an item with which the user is interacting; identify, based on detecting the negative emotion of the user, a task being performed by the user in relation to the identified item; and obtain, based on identifying the item and the task, information to aid the user in performing the identified task in relation to the identified item, where the information includes information, obtained from a memory associated with the device, relating to performing the task in relation to the identified item, document-based information, obtained from a network, relating to performing the task in relation to the identified item, and video-based information relating to performing the task in relation to the identified item. The group of instructions further causes the one or more processors to provide the obtained information to the user.

According to some possible implementations, one or more instructions, of the group of instructions, to identify the item or to identify the task include one or more instructions to identify at least one of the task or the item based on analyzing one or more of an image or video of the user performing the task in relation to the item, a search history associated with the user, a purchase history associated with the user, social activity associated with the user, or a verbal communication associated with the user or another user.

According to some possible implementations, the item corresponds to an application executing on the device, and one or more instructions, of the group of instructions, to obtain the information to aid the user in performing the task in relation to the item include one or more instructions to obtain information from a help document associated with the application.

According to some possible implementations, one or more instructions, of the group of instructions, to obtain the information to aid the user in performing the task in relation to the item include the one or more instructions to send a search query, over the network, to a server, where the search query includes information identifying the task and the item; and one or more instructions to receive, based on sending the search query, the document-based information and the video-based information.

According to some possible implementations, the instructions further include one or more instructions to provide a list of options to the user, where the list of options includes a first option to obtain the information, from the memory associated with the device, relating to performing the task in relation to the identified item, a second option to obtain the document-based information, and a third option to obtain the video-based information. The instructions further include one or more instructions to detect a selection of the first option, the second option, or the third option, and where one or more instructions, of the group of instructions, to provide the information to the user include one or more instructions to provide the obtained information based on the selection of the first option, the second option, or the third option.

According to some possible implementations, one or more instructions, of the group of instructions, to provide the obtained information include one or more instructions to provide the obtained information via a display device.

According to some possible implementations, a system includes means for detecting a negative emotion of a user; means for identifying, based on detecting the negative emotion of the user, a task being performed by the user in relation to an item; and means for obtaining, based on identifying the task, information to aid the user in performing the identified task in relation to the item, where the information includes at least one of information, obtained from a memory associated with the device, in a help document, a user manual, or an instruction manual relating to performing the task in relation to the item; information, obtained from a network, identifying a document relating to performing the task in relation to the item; or information identifying a video relating to performing the task in relation to the item. The system further includes means for providing the obtained information to the user.

The above discussion mentions examples in which some implementations may be implemented via one or more methods performed by one or more processors of one or more devices. In some implementations, one or more systems and/or one or more devices may be configured to perform one or more of the acts mentioned above. In some implementations, a computer-readable medium may include computer-executable instructions which, when executed by one or more processors, cause the one or more processors to perform one or more of the acts mentioned above.

### BRIEF DESCRIPTION OF THE DRAWINGS

The accompanying drawings, which are incorporated in and constitute a part of this specification, illustrate one or more implementations described herein and, together with the description, explain these implementations. In the drawings:

FIGS. 1A-1C are diagrams illustrating an overview of an example implementation described herein;

FIG. 2 is a diagram of an example environment in which systems and/or methods described herein may be implemented;

FIG. 3 is a flowchart of an example process for providing help information to a user;

FIG. 4 is an example configuration of a user interface via which help information may be provided;

FIGS. 5A-5D are an example of the process described with respect to FIG. 3;

FIGS. 6A-6C are another example of the process described with respect to FIG. 3; and

FIG. 7 is a diagram of an example of a generic computer device and a generic mobile computer device.

### DETAILED DESCRIPTION

The following detailed description refers to the accompanying drawings. The same reference numbers in different drawings may identify the same or similar elements.

Systems and/or methods, as described herein, may automatically provide help information to an individual when the individual is exhibiting a negative emotion, such as exhibiting a look of puzzlement, frustration, anger, disappointment, etc. For example, upon detection that the individual is getting frustrated performing a task on a computer device, systems and/or methods, as described herein, may identify the application with which the individual is interacting, identify the task being performed in relation to the application, obtain help information relating to performance of the task in relation to the application, and visually provide the help information to the individual. In some implementations, the help information may take the form of a help document stored on the computer device, textual help information obtained from a network, a video relating to performing the task in relation to the application, etc.

A document, as the term is used herein, is to be broadly interpreted to include any machine-readable and machine-storable work product. A document may include, for example, an e-mail, a file, a combination of files, one or more files with embedded links to other files, a news article, a blog, a discussion group forum, etc. In the context of the Internet, a common document is a web page. Web pages often include textual information and may include embedded information, such as meta information, images, hyperlinks, etc., and/or embedded instructions, such as Javascript.

In situations in which systems and/or methods, as described herein, monitor users, collect personal information about users, or make use of personal information, the users may be provided with an opportunity to control whether programs or features monitor users or collect user information (e.g., information about a user's social network, social actions or activities, profession, a user's preferences, a user's current location, etc.), or to control whether and/or how to receive content that may be more relevant to the user. In addition, certain data may be treated in one or more ways before the data is stored and/or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected and used.

FIGS. 1A-1C are diagrams illustrating an overview 100 of an example implementation described herein. With reference to FIG. 1A, assume a user, of a user device, is inserting paragraph numbers into a document of a word processing application. Assume further that the user is getting frustrated as a result of not being able to make the paragraph numbers sequential. The user device may detect the user's frustration, based, for example, on detecting a look of frustration, anger, disappointment, etc. on the user's face. In response, the user device may identify the application with which the user is interacting and the task that the user is attempting to perform. In overview 100, the user device may determine that the user is attempting to insert paragraph numbers into a document of the word processing application. The user device may then obtain help information relating to inserting paragraph numbers into documents for the particular word processing application. For overview 100, assume that the user device obtains information from a help file of the particular word processing application, information from an online user manual, information from one or more web pages, and a video that explains how to insert paragraph numbers into a document using the particular word processing application. The user device may present a user interface that allows the user to select the type of help information that the user desires, as shown in FIG. 1B.

Assume, for overview 100, that the user selects the help file. In response, the user device may provide the help file to the user, as shown in FIG. 1C. In this way, the user device may provide help information, to the user, without the user having to manually obtain the help information. By providing the help information in this manner, the user's frustration with performing the task may be quickly eliminated.

FIG. 2 is a diagram of an example environment 200 in which systems and/or methods described herein may be implemented. Environment 200 may include a user device 210, a server 220, and a network 230.

User device 210 may include a device, or a collection of devices, that is capable of detecting an emotion of a user and obtaining help information when the detected emotion is negative. Examples of user device 210 may include a smart phone, a personal digital assistant, a laptop, a tablet computer, a personal computer, and/or another similar type of device. In some implementations, user device 210 may include a browser via which help information may be presented on a display associated with user device 210.

Server 220 may include a server device or a collection of server devices that may be co-located or remotely located. In some implementations, server 220 may store help information and provide particular help information, based on a request from user device 210. In some implementations, server 220 may receive a request for help information from user device 210, obtain help information from a remote location, such as from one or more other servers, based on the received request, and provide the obtained help information to user device 210. In some implementations, server 220 may include a search engine.

Network 230 may include one or more wired and/or wireless networks. For example, network 230 may include a local area network (“LAN”), a wide area network (“WAN”), a telephone network, such as the Public Switched Telephone Network (“PSTN”) or a cellular network, an intranet, the Internet, and/or another type of network or a combination of these or other types of networks. User device 210 and server 220 may connect to network 230 via wired and/or wireless connections. In other words, user device 210 and/or server 220 may connect to network 230 via a wired connection, a wireless connection, or a combination of a wired connection and a wireless connection.

Although FIG. 2 shows example components of environment 200, in some implementations, environment 200 may include additional components, fewer components, different components, or differently arranged components than those depicted in FIG. 2. Additionally, or alternatively, one or more components of environment 200 may perform one or more tasks described as being performed by one or more other components of environment 200.

FIG. 3 is a flowchart of an example process 300 for providing help information to a user. In some implementations, process 300 may be performed by user device 210. In some implementations, some or all of the blocks described below may be performed by a different device or group of devices, including or excluding user device 210.

Process 300 may include detecting a negative emotion of a user (block 310). For example, user device 210 may monitor the user visually and/or audibly and may detect a negative emotion of the user based on the monitoring. Examples of negative emotions may include frustration, anger, disappointment, disgust, sadness, puzzlement, etc. In some implementations, user device 210 may include a first classifier for detecting a negative emotion, of a user, based on monitoring the user's facial expression. For example, the first classifier may be trained to detect negative emotion based on a position of a user's mouth and/or eyes. Examples of negative emotions that may be related to the position of the user's mouth include the lips being placed into a frowning position, the lips being placed into a pouting position, and/or other positioning of the mouth that may reflect a negative emotion. Examples of negative emotions that may be related to the position of the user's eyes include the inner corners of the eyebrows being raised, which forms wrinkles in the medial part of the brow; the outer portion of the eyebrows being raised, which forms wrinkles in the lateral part of the brow; the eyebrows being pulled down and together, which forms vertical wrinkles between the eyebrows and horizontal wrinkles near the nasion; and/or any other positioning of the eyes that may reflect a negative emotion. The first classifier may receive visual information regarding the facial expression of the user and generate a score based on the received visual information.

In some implementations, user device 210 may include a second classifier for detecting a negative emotion, of a user, based on monitoring the user's body language. For example, the second classifier may be trained to detect negative emotion based on detecting a slouched or slumped body posture, shaking, thrusting, or titling of the user's head, shaking of the user's fist(s), self-grooming or self-touching behavior, throwing an object, and/or any other body language that may reflect a negative emotion. The second classifier may receive visual information regarding the body language of the user and generate a score based on the received visual information.

In some implementations, user device 210 may include a third classifier for detecting a negative emotion, of a user, based on monitoring audible signals from the user. For example, the third classifier may be trained to detect negative emotion based on detecting a change in pitch of the user's voice, a change in volume of the user's voice, a change in cadence of the user's voice, a change in the user's use of vocabulary, the use of particular words and/or phrases (e.g., a curse word), the user repeating a word or phrase, and/or any other audible signal that may reflect a negative emotion. The third classifier may receive information regarding the audible signals from the user and generate a score based on the received audible signals.

In some implementations, user device 210 may generate a total score for a detected emotion based on the score from the first classifier, the score from the second classifier, and/or the score from the third classifier. In some implementations, user device 210 may generate a total score for a detected emotion based on a weighted combination of the score from the first classifier, the score from the second classifier, and/or the score from the third classifier. For example, user device 210 may assign a weight value to the score from the first classifier, the score from the second classifier, and/or the score from the third classifier. The weight values may differ—in other words, the amount that each of the score from the first classifier, the score from the second classifier, and/or the score from the third classifier contributes to the total score may vary. User device 210 may combine the weighted score from the first classifier, the weighted score from the second classifier, and/or the weighted score from the third classifier to generate the total score.

In some implementations, user device 210 may compare the total score to a first threshold. For example, if the total score equals or exceeds the first threshold, user device 210 may determine that the detected emotion is a negative emotion. In some implementations, user device 210 may compare the total score to one or more additional thresholds. For example, user device 210 may compare the total score to a second threshold when the total score is less than the first threshold. The second threshold may have a value that is lower than the first threshold. If the total score is less than a second threshold, user device 210 may determine that the detected emotion is not a negative emotion. If, on the other hand, the total score is less than the first threshold and is equal to or greater than the second threshold, user device 210 may prompt the user as to whether the user needs help. In some implementations, the first threshold and/or the second threshold may be user configurable.

Process 300 may include identifying an item with which the user is interacting (block 320). For example, user device 210 may identify the item with which the user is interacting at the time that the negative emotion is detected. When the user is interacting with user device 210, user device 210 may identify the application, on user device 210, with which the user is currently interacting.

When the user is not interacting with user device 210, user device 210 may identify the item, outside of user device 210, with which the user is interacting. In some implementations, user device 210 may capture an image or video of the item and identify the item using, for example, an image recognition technique. For example, user device 210 may generate a recognition score, for the item, that reflects the probability that the item is correctly identified. In some example implementations, user device 210 may modify the recognition score based on one or more factors. For example, user device 210 may modify the recognition score based on information regarding the user's browser history. The browser history may include, for example, a search history and/or a purchase history. As an example, assume that the user is assembling a bicycle and is getting frustrated trying to attach the brakes. User device 210 may detect that the user is getting frustrated and may attempt to identify that the item with which the user is interacting. Assume that user device 210 is able to identify that the user is interacting with a bicycle, but is unable to identify the particular brand of bicycle. Assume further that user device 210 determines that the user has recently performed a search for a Brand X bicycle and/or has recently purchased a Brand X bicycle online. Thus, user device 210 may modify the recognition score, of the item, based on the user's search history and/or purchase history.

Additionally, or alternatively, user device 210 may modify the recognition score based on information regarding social activity associated with the user. The social activity may include, for example, social activity of the user and/or the user's social contacts. The user's social contacts may be identified based on the user's communications, the user's address book, and/or the user's account on one or more social networks. Examples of activity data may include whether the user or the user's social contacts have expressed interest in the item by, for example, providing a positive rating for the item, requesting additional information regarding the item, bookmarking a document that references the item, or the like. Continuing with the example above, assume that user device 210 determines that the user has recently posted a comment about a Brand X bicycle to a social network. Thus, user device 210 may modify the recognition score, of the item, based on social activity associated with the user.

Additionally, or alternatively, user device 210 may modify the recognition score based on voice communications. For example, user device 210 may capture voice communications of the user and/or another user and parse the voice communications for information identifying the item. Continuing with the example above, assume that user device 210 detects that user has said “I'm downstairs putting Katie's Brand X bike together.” Thus, user device 210 may modify the recognition score, of the item, based on verbal communications of the user or another user.

User device 210 may compare the recognition score, as modified by browser history, social activity, and/or verbal communications, to a threshold. In some implementations, if the recognition score equals or exceeds the threshold, user device 210 may associate the item with the negative emotion. If, on the other hand, the recognition score is less than the threshold, user device 210 may prompt the user to identify the item with which the user is interacting. In some implementations, the threshold may be user configurable.

Process 300 may include identifying a task being performed by the user (block 330). For example, user device 210 may identify the task being performed in connection with the item at the time that the negative emotion is detected. When the user is interacting with user device 210, user device 210 may identify task being performed in relation to the identified application, on user device 210. As an example, assume that the user is getting frustrated attempting to make the font of a document in a word processing application uniform. User device 210 may identify the item as the word processing application and the task as adjusting the font of a word processing document.

In some implementations, user device 210 may use additional information in identifying the task. For example, user device 210 may use voice communications in identifying the task that the user is attempting to perform. In some implementations, user device 210 may capture voice communications of the user and/or another user and parse the voice communications for information identifying the task. Continuing with the example above regarding attempting to make the font of a word processing document uniform, assume that user device 210 detects that user has said “I can't get this font to be the same!” User device 210 may use this verbal communication to help in identifying the task that the user is attempting to perform.

When the user is not interacting with user device 210, user device 210 may identify the task based on visual and/or audible information. In some implementations, user device 210 may identify the task generally or may identify the particular step of the task that the user is attempting to perform. As one example, assume that the user is attempting to put the legs on a particular brand of dining room table and is getting frustrated. User device 210 may identify the item as the particular brand of dining room table and may generally identify the task as assembling the particular brand of dining room table or specifically as putting the legs on the particular brand of dining room table.

In some implementations, user device 210 may capture an image and/or video of the user interacting with the item and identify the task based on analyzing the image and/or video. Continuing with the bicycle example above, user device 210 may capture a video of the user interacting with the bicycle and the part of the bicycle with which the user is interacting. User device 210 may generate a recognition score, for the task, based on the captured video. In some example implementations, user device 210 may modify the recognition score based on one or more factors. For example, user device 210 may modify the recognition score based on information regarding the user's browser history (e.g., a search history and/or a purchase history). Continuing with the bicycle example above, assume that the user recently searched for and/or purchased a new set of brakes for a Brand X bicycle. Thus, user device 210 may use search history and/or purchase history to help in identifying the task that the user is attempting to perform.

Additionally, or alternatively, user device 210 may modify the recognition score based on information regarding the social activity of the user and/or the user's social contacts. Continuing with the example above, assume that user device 210 determines that the user's social contact has recommended, via a social network, a particular brand of brakes to the user. User device 210 may use this social activity to help in identifying the task that the user is attempting to perform.

Additionally, or alternatively, user device 210 may modify the recognition score based on voice communications. For example, user device 210 may capture voice communications of the user and/or another user and parse the verbal communications for information identifying the task. Continuing with the example above, assume that user device 210 detects that user has said “Ugh! These brakes!” User device 210 may use this verbal communication to help in identifying the task that the user is attempting to perform.

User device 210 may compare the recognition score, as modified by browser history, social activity, and/or verbal communications, to a threshold. In some implementations, if the recognition score equals or exceeds the threshold, user device 210 may associate the task with the negative emotion. If, on the other hand, the recognition score is less than the threshold, user device 210 may prompt the user to identify the task that the user is attempting to perform. In some implementations, the threshold may be user configurable.

Process 300 may include obtaining help information relating to the task (block 340). For example, user device 210 may obtain help information based on the identified item and the identified task. In some implementations, user device 210 may generate a search query. The search query may include information identifying the item and the task. In some implementations, user device 210 may perform a search of user device 210 (or another device associated with the user) for help information relating to the identified item and the identified task. For example, user device 210 may search the memory, of user device 210, to obtain a help document and/or a user manual associated with the identified item and task. As one example, assume that the item is a word processing application and the task is adjusting the font in a word processing document. In this example, user device 210 may search a help file of the word processing application for help information relating to adjusting the font.

In some implementations, user device 210 may send the search query to another device, such as server 220, to obtain the help information. In some implementations, server 220 may perform a search based on the search query. For example, server 220 may perform a search for documents and/or videos relating to the identified item and task. Server 220 may provide, to user device 210, a ranked list of information identifying documents and/or a ranked list of information identifying videos relating to the identified item and task. Continuing with the bicycle example above, server 220 may perform a search for documents and/or videos relating to attaching brakes to a Brand X bicycle and provide, to user device 210, a ranked list of links to documents and/or videos.

Process 300 may include providing help information to the user (block 350). For example, user device 210 may provide help information, audibly and/or visually, to the user to aid the user in performing the identified task in relation to the identified item. In some implementations, user device 210 may provide a user interface, to the user, that identifies different categories of help information. For example, the user interface may identify a group of different help categories, such as a help document related to an application executing on user device 210, a user manual, a web-based document (such as a web page and/or information from an online chat room), a video, and/or another type of help information. User device 210 may detect selection of one of the help categories in the user interface and may provide, based on the selection, help information based on the selected help category. An example user interface that may be provided to the user is described below with respect to FIG. 4.

In some implementations, user device 210 may provide, for display, that portion of the help information that directly relates to the identified task being performed. For example, returning to the bicycle example above, assume that user device 210 obtains an instruction manual for assembling a Brand X bicycle. Upon the user selection of the instruction manual, user device 210 may provide, for display, that portion of the instruction manual that relates to attaching the brakes.

In some implementations, user device 210 may provide help information to the user without the user selecting a help category or particular help information. For example, user device 210 may be configured to give a higher priority to one category of help information than the priority given to the other categories of help information and may automatically provide help information from that higher priority category. For example, assume that user device 210 prioritizes videos ahead of other types of help information. If a video has been identified that relates to the identified item and task, user device 210 may automatically provide the identified video to the user.

In some implementations, user device 210 may continue to monitor the user after providing the help information. In those situations where user device 210 determines that the negative emotion has been eliminated or user device 210 detects a positive emotion after providing the help information, user device 210 may store information, indicating that the appropriate help information was provided to the user. Similarly, in those situations where user device 210 determines that the negative emotion remains after providing the help information, user device 210 may store information, indicating that the appropriate help information was not provided to the user. Thus, user device 210 may receive positive and negative feedback, which may aid user device 210 in subsequently identifying items and/or tasks, and/or obtaining help information.

While FIG. 3 shows process 300 as including a particular quantity and arrangement of blocks, in some implementations, process 300 may include fewer blocks, additional blocks, or a different arrangement of blocks. Additionally, or alternatively, some of the blocks may be performed in parallel.

FIG. 4 is an example configuration of a user interface 400 via which help information may be provided. As shown, user interface 400 may include a help file and user/instruction manual area 410, a videos area 420, and a general documents area 430.

Help file and user/instruction manual area 410 may include an area, of user interface 400, where links to help documents associated with applications executing on user device 210, user manuals, and/or instruction manuals may be provided. In some implementations, the information, provided in help file and user/instruction manual area 410, may include information that is retrieved from a memory associated with user device 210. In some implementations, some or all of the information, provided in help file and user/instruction manual area 410, may include information that is retrieved from a remote location, such as server 220 or another device or devices.

Videos area 420 may include an area, of user interface 400, where links to videos may be provided. In some implementations, the videos, provided in videos area 420, may correspond to the top ranking videos obtained from server 220 and relating to an identified item and task.

General documents area 430 may include an area, of user interface 400, where links to documents may be provided. In some implementations, the documents, provided in general documents area 430, may correspond to the top ranking documents obtained from server 220 and relating to an identified item and task.

As an example, assume again that user is assembling a Brand X bicycle and has gotten frustrated trying to attach the brakes. User device 210 has detected the user's frustration and obtained help information. As shown in FIG. 4, the help information may include an instruction manual for assembling the Brand X bicycle, a group of videos relating to attaching brakes to a Brand X bicycle, and a group of documents relating to attaching brakes to a Brand X bicycle. The user may select any of the links provided in user interface 400. Upon selection of a link, user device 210 may obtain the corresponding instruction manual, video, or document. In this way, user device 210 may provide information that may aid the user in attaching the brakes.

Although FIG. 4 shows an example configuration of a user interface 400, in some implementations, user interface 400 may include additional areas, different areas, fewer areas, or differently arranged areas than those depicted in FIG. 4.

FIGS. 5A-5D are an example 500 of the process described above with respect to FIG. 3. With reference to FIG. 5A, assume that a user is attempting to play a particular music video on user device 210. The user selects the particular music video, which causes a video player, on user device 210, to launch. Assume, as shown in FIG. 5A, that instead of the video player playing the particular music video, the video player locks up while attempting to play the particular music video. Assume further that user device 210 monitors the facial expression of the user, using a camera 510 associated with user device 210, and detects that the user is disappointed. User device 210 may, based on detecting that the user is disappointed, identify that the item with which the user is interacting is the video player and that the task that the user is attempting to perform is playing the particular music video.

With reference to FIG. 5B, user device 210 may obtain help information relating to the identified item and the identified task. User device 210 may obtain a help document and/or a user manual, associated with the video player, from a memory associated with user device 210. User device 210 may also provide a search query 520 to server 220. Search query 520 may include information identifying the item and the task. Server 220 may perform a search to obtain videos, manuals, and/or documents relating to search query 520. Server 220 may provide, to user device 210 and as help information 530, one or more lists of search results. The search results may correspond to links to videos, manuals, and/or documents identified based on search query 520.

With reference to FIG. 5C, user device 210 may provide a user interface 540 to the user. User interface 540 may prompt the user to identify the type of help information that the user desires. As shown in FIG. 5C, user interface 540 allows the user to select, as help, a help document associated with the video player, documents relating to the identified item and task, or videos relating to the identified item and task. Assume that the user selects the help document. In response, user device 210 may provide, for display, a help document 550 associated with the video player to the user, as shown in FIG. 5D. User device 210 may provide a portion of help document 550 directed to playing music videos. In this way, user device 210 may automatically provide help information, to a user, based on detecting that the user is expressing a negative emotion.

FIGS. 6A-6C are another example 600 of the process described above with respect to FIG. 3. With reference to FIG. 6A, assume that a user is assembling a dollhouse that is to be given as a gift. The user has assembled most of the dollhouse, but is struggling with the roof. Assume that user device 210 is monitoring the user and detects, based on the user's facial expression or body language, that the user is angry. User device 210 may, based on detecting that the user is angry, identify that the item with which the user is interacting is a dollhouse and that the task that the user is attempting to perform is placing the roof on the dollhouse. Assume further that user device 210 identifies the particular brand of dollhouse based on one or more of visual identification of the brand, the user's browser history (such as the user's search history and/or purchase history), and/or audible identification of the brand. Assume, for example 600, that user device 210 identifies the brand of the dollhouse as Brand Y.

With reference to FIG. 6B, user device 210 may obtain help information relating to the identified item and the identified task. User device 210 may provide a search query 610 to server 220. Search query 610 may include information identifying the item and the task. Server 220 may perform a search to obtain videos, manuals (e.g., an instruction manual), and/or documents relating to search query 610. Server 220 may provide, to user device 210 and as help information 620, one or more lists of search results. The search results may correspond to links to videos, manuals, and/or documents identified based on search query 610.

Assume, for example 600, that user device 210 is configured to rank videos higher than documents or manuals. Moreover, assume that user device 210 is further configured to automatically provide a video if a video is determined to be particularly relevant to the identified item and task and that one of the videos, identified by server 220, is determined to be particularly relevant. Thus, with reference to FIG. 6C, user device 210 may provide the particularly relevant video, as relevant video 630, to the user. In this way, user device 210 may automatically provide help information, to a user, based on detecting that the user is expressing a negative emotion.

FIG. 7 is a diagram of an example of a generic computing device 700 and a generic mobile computing device 750, which may be used with the techniques described herein. Generic computing device 700 or generic mobile computing device 750 may correspond to, for example, a user device 210 and/or a server 220. Computing device 700 is intended to represent various forms of digital computers, such as laptops, desktops, workstations, personal digital assistants, servers, blade servers, mainframes, and other appropriate computers. Mobile computing device 750 is intended to represent various forms of mobile devices, such as personal digital assistants, cellular telephones, smart phones, and other similar computing devices. The components shown in FIG. 7, their connections and relationships, and their functions, are meant to be examples only, and are not meant to limit implementations described herein.

Computing device 700 may include a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. Processor 702 can process instructions for execution within the computing device 700, including instructions stored in the memory 704 or on the storage device 706 to display graphical information for a graphical user interface (GUI) on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations, as a server bank, a group of blade servers, or a multi-processor system, etc.

Memory 704 stores information within the computing device 700. In some implementations, memory 704 includes a volatile memory unit or units. In some implementations, memory 704 includes a non-volatile memory unit or units. The memory 704 may also be another form of computer-readable medium, such as a magnetic or optical disk. A computer-readable medium may refer to a non-transitory memory device. A memory device may refer to storage space within a single storage device or spread across multiple storage devices.

The storage device 706 is capable of providing mass storage for the computing device 700. In some implementations, storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 704, storage device 706, or memory on processor 702.

High speed controller 708 manages bandwidth-intensive operations for the computing device 700, while low speed controller 712 manages lower bandwidth-intensive operations. Such allocation of functions is exemplary only. In one implementation, high-speed controller 708 is coupled to memory 704, display 716 (e.g., through a graphics processor or accelerator), and to high-speed expansion ports 710, which may accept various expansion cards (not shown). In this implementation, low-speed controller 712 is coupled to storage device 706 and low-speed expansion port 714. The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Computing device 700 may be implemented in a number of different forms, as shown in the figure. For example, computing device 700 may be implemented as a standard server 720, or multiple times in a group of such servers. Computing device 700 may also be implemented as part of a rack server system 724. In addition, computing device 700 may be implemented in a personal computer, such as a laptop computer 722. Alternatively, components from computing device 700 may be combined with other components in a mobile device (not shown), such as mobile computing device 750. Each of such devices may contain one or more of computing devices 700, 750, and an entire system may be made up of multiple computing devices 700, 750 communicating with each other.

Mobile computing device 750 may include a processor 752, memory 764, an input/output (“I/O”) device, such as a display 754, a communication interface 766, and a transceiver 768, among other components. Mobile computing device 750 may also be provided with a storage device, such as a micro-drive or other device, to provide additional storage. Each of the components 750, 752, 764, 754, 766, and 768 are interconnected using various buses, and several of the components may be mounted on a common motherboard or in other manners as appropriate.

Processor 752 can execute instructions within mobile computing device 750, including instructions stored in memory 764. Processor 752 may be implemented as a chipset of chips that include separate and multiple analog and digital processors. Processor 752 may provide, for example, for coordination of the other components of mobile computing device 750, such as control of user interfaces, applications run by mobile computing device 750, and wireless communication by mobile computing device 750.

Processor 752 may communicate with a user through control interface 758 and display interface 756 coupled to a display 754. Display 754 may be, for example, a TFT LCD (Thin-Film-Transistor Liquid Crystal Display) or an OLED (Organic Light Emitting Diode) display, or other appropriate display technology. Display interface 756 may comprise appropriate circuitry for driving display 754 to present graphical and other information to a user. Control interface 758 may receive commands from a user and convert them for submission to the processor 752. In addition, an external interface 762 may be provide in communication with processor 752, so as to enable near area communication of mobile computing device 750 with other devices. External interface 762 may provide, for example, for wired communication in some implementations, or for wireless communication in other implementations, and multiple interfaces may also be used.

Memory 764 stores information within mobile computing device 750. Memory 764 can be implemented as one or more of a computer-readable medium or media, a volatile memory unit or units, or a non-volatile memory unit or units. Expansion memory 774 may also be provided and connected to mobile computing device 750 through expansion interface 772, which may include, for example, a SIMM (Single In Line Memory Component) card interface. Such expansion memory 774 may provide extra storage space for device 750, or may also store applications or other information for mobile computing device 750. Specifically, expansion memory 774 may include instructions to carry out or supplement the processes described above, and may include secure information also. Thus, for example, expansion memory 774 may be provide as a security component for mobile computing device 750, and may be programmed with instructions that permit secure use of device 750. In addition, secure applications may be provided via the SIMM cards, along with additional information, such as placing identifying information on the SIMM card in a non-hackable manner.

Expansion memory 774 may include, for example, flash memory and/or NVRAM memory. In some implementations, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Mobile computing device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver component 770 may provide additional navigation- and location-related wireless data to mobile computing device 750, which may be used as appropriate by applications running on mobile computing device 750.

Mobile computing device 750 may also communicate audibly using audio codec 760, which may receive spoken information from a user and convert it to usable digital information. Audio codec 760 may likewise generate audible sound for a user, such as through a speaker, e.g., in a handset of mobile computing device 750. Such sound may include sound from voice telephone calls, may include recorded sound (e.g., voice messages, music files, etc.) and may also include sound generated by applications operating on mobile computing device 750.

Mobile computing device 750 may be implemented in a number of different forms, as shown in the figure. For example, mobile computing device 750 may be implemented as a cellular telephone 780. Mobile computing device 750 may also be implemented as part of a smart phone 782, personal digital assistant, a watch 784, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device (e.g., magnetic discs, optical disks, memory, Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

Systems and methods, described herein, may provide help information, to a user, based on detecting that the user is expressing a negative emotion. The help information may be provided with no or minimal interaction with the user. In this way, systems and methods, as described herein, can quickly eliminate the user's negative emotion.

The foregoing description provides illustration and description, but is not intended to be exhaustive or to limit the implementations to the precise form disclosed. Modifications and variations are possible in light of the above disclosure or may be acquired from practice of the implementations.

As used herein, the term component is intended to be broadly interpreted to refer to hardware or a combination of hardware and software, such as software executed by a processor.

It will be apparent that systems and methods, as described above, may be implemented in many different forms of software, firmware, and hardware in the implementations illustrated in the figures. The actual software code or specialized control hardware used to implement these systems and methods is not limiting of the implementations. Thus, the operation and behavior of the systems and methods were described without reference to the specific software code—it being understood that software and control hardware can be designed to implement the systems and methods based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with the phrase “one or more.” Where only one item is intended, the term “one” or similar language is used. Further, the phrase “based on” is intended to mean “based, at least in part, on” unless explicitly stated otherwise.

What is claimed is:

1. A method comprising:
detecting, by one or more processors of a device, a negative emotion of a user;
identifying, by the one or more processors and based on detecting the negative emotion of the user, a task being performed by the user in relation to an item;
obtaining, by the one or more processors and based on identifying the task, information to aid the user in performing the identified task in relation to the item,
the information including at least one of:
information, obtained from a memory associated with the device, in a help document, a user manual, or an instruction manual relating to performing the task in relation to the item,
information, obtained from a network, identifying a document relating to performing the task in relation to the item, or
information identifying a video relating to performing the task in relation to the item; and
providing, by the one or more processors, the obtained information to the user.

2. The method of claim 1, where identifying the task includes:
identifying at least one of the task or the item based on analyzing one or more of:
an image or video of the user performing the task in relation to the item,
a search history associated with the user,
a purchase history associated with the user,
social activity associated with the user, or
a verbal communication associated with the user or another user.

3. The method of claim 1, where the item corresponds to an application executing on the device, and
where obtaining the information to aid the user in performing the task in relation to the item includes:
obtaining information from a help document of the application.

4. The method of claim 1, where obtaining the information to aid the user in performing the task in relation to the item includes:
sending a search query, over the network, to a server,
the search query including information identifying the task and the item, and
receiving, based on sending the search query, at least one of:
the information identifying a document relating to performing the task in relation to the item, or
the information identifying a video relating to performing the task in relation to the item.

5. The method of claim 1, further comprising:
providing a list of options to the user,
the list of options including:
a first option to obtain a help document associated with the item, a user manual, or an instruction manual,
a second option to obtain a document from the network, and
a third option to obtain a video from the network, and
detecting a selection of the first option, the second option, or the third option, and
where providing the obtained information to the user includes:
providing the obtained information based on the selection of the first option, the second option, or the third option.

6. The method of claim 1, where the task includes a plurality of steps,
where identifying the task includes:
identifying a particular step, of the plurality of steps, being performed by the user when the negative emotion was detected, and
where obtaining the information to aid the user in performing the task includes:
obtaining information relating to the particular step.

7. The method of claim 1, where providing the obtained information includes:
providing the obtained information on a display device.

8. A system comprising:
one or more processors to:
detect a negative emotion of a user,
identify, based on detecting the negative emotion of the user, a task being performed by the user in relation to an item,
when identifying the task, the one or more processors being to:
identify at least one of the task or the item based on analyzing one or more of:
an image or video of the user performing the task in relation to the item,
a search history associated with the user,
a purchase history associated with the user, or
social activity associated with the user,
obtain, based on identifying the task, information to aid the user in performing the identified task in relation to the item, and
provide the obtained information to the user.

9. The system of claim 8, where the information includes at least one of:
information, from a memory associated with the device, in a help document, a user manual, or an instruction manual,
document-based information, obtained from a network, relating to performing the task in relation to the identified item, or
video-based information relating to performing the task in relation to the identified item.

10. The system of claim 8, where the item corresponds to an application being executed by a processor of the one or more processors, and
where, when obtaining the information to aid the user in performing the task in relation to the item, the one or more processors are to:
obtain information from a help document associated with the application.

11. The system of claim 8, where, when obtaining the information to aid the user in performing the task, the one or more processors are to:
send a search query, via the network, to a server,
the search query including information identifying the item and the task, and
receive, based on sending the search query, the information to aid the user in performing the identified task in relation to the item.

12. The system of claim 8, where the one or more processors are further to:
provide a list of options to the user,
the list of options including:
a first option to obtain one or more of a help document, a user manual, or an instruction manual,
a second option to obtain a document from the network, and
a third option to obtain a video from the network, and
detect a selection of the first option, the second option, or the third option, and
where, when providing the obtained information to the user, the one or more processors are to:
provide the obtained information based on the selection of the first option, the second option, or the third option.

13. The system of claim 8, where the task includes a plurality of steps,
where when identifying the task, the one or more processors are to:
identify a particular step, of the plurality of steps, being performed by the user when the negative emotion was detected, and
where when obtaining the information to aid the user in performing the task, the one or more processors are to:
obtain information relating to the particular step.

14. The system of claim 8, where, when providing the obtained information, the one or more processors are to:
provide the obtained information on a display device.

15. A computer-readable medium for storing instructions, the instructions comprising:
a plurality of instructions, which, when executed by one or more processors of a device, cause the one or more processors to:
detect a negative emotion of a user,
identify, based on detecting the negative emotion of the user, an item with which the user is interacting,
identify, based on detecting the negative emotion of the user, a task being performed by the user in relation to the identified item,
obtain, based on identifying the item and the task, information to aid the user in performing the identified task in relation to the identified item,
the information including:
information, obtained from a memory associated with the device, relating to performing the task in relation to the identified item,
document-based information, obtained from a network, relating to performing the task in relation to the identified item, and
video-based information relating to performing the task in relation to the identified item; and
provide the obtained information to the user.

16. The computer-readable medium of claim 15, where one or more instructions, of the plurality of instructions, to identify the item or to identify the task include:
one or more instructions to identify at least one of the task or the item based on analyzing one or more of:
an image or video of the user performing the task in relation to the item,
a search history associated with the user,
a purchase history associated with the user,
social activity associated with the user, or
a verbal communication associated with the user or another user.

17. The computer-readable medium of claim 15, where the item corresponds to an application executing on the device, and
where one or more instructions, of the plurality of instructions, to obtain the information to aid the user in performing the task in relation to the item include:
one or more instructions to obtain information from a help document associated with the application.

18. The computer-readable medium of claim 15, where one or more instructions, of the plurality of instructions, to obtain the information to aid the user in performing the task in relation to the item include:
one or more instructions to send a search query, over the network, to a server,
the search query including information identifying the task and the item, and
one or more instructions to receive, based on sending the search query, the document-based information and the video-based information.

19. The computer-readable medium of claim 15, where the instructions further comprise:
one or more instructions to provide a list of options to the user,
the list of options including:
a first option to obtain the information, from the memory associated with the device, relating to performing the task in relation to the identified item,
a second option to obtain the document-based information, and
a third option to obtain the video-based information, and
one or more instructions to detect a selection of the first option, the second option, or the third option, and
where one or more instructions, of the plurality of instructions, to provide the information to the user include:
one or more instructions to provide the obtained information based on the selection of the first option, the second option, or the third option.

20. The computer-readable medium of claim 15, where one or more instructions, of the plurality of instructions, to provide the obtained information include:
one or more instructions to provide the obtained information via a display device.
